(19) United States
(12) Patent Application Publication
(10) Pub. No.: US 2009/0050664 A1
(43) Pub. Date: Feb. 26, 2009

(54) Coilable fastener cap strip without a central core

(76) Inventor: Don Ross Henza, Greensboro, NC (US)

Correspondence Address: GILBERT J. ANDIA, JR., 101 W. FRIENDLY AVE., SUITE 500, GREENSBORO, NC, 27401, US

(21) Appl. No.: 11/894,975

(22) Filed: Aug. 22, 2007

(51) Int. Cl. B25C 7/00

(52) U.S. Cl. 227/16

(57) ABSTRACT

A strip of fastener caps made up of a plurality of disks including an inner coil disk and an end disk. Each disk has a circumferential edge with a breakable yet flexible member that is integral with each adjacent disk edge. A common centerline passes edgewise through each of the disks. The location of a first and second predetermined number of the breakable members alternates from one side of the common centerline to the other. A notch within the circumferential edge of the inner coil disk is for engaging at least one breakable member connecting other disks within the strip of fastener caps. A section of the plurality of disks is coiled into an inner loop such that the inner coil disk's notch engages a breakable member between other disks wherein the inner coil disk is immobile relative to the disks making up the inner disk loop. The alternating pattern of breakable members allows for interlacing the breakable members and overlapping the disks at the end of the coil including the end disk such that tension is maintained on the coiled cap strip. The interlacing of the breakable members at the cap strips end eliminates the need for a core and external means such as tape, rubber bands and/or adhesive to maintain the coil of the cap strip.

### BACKGROUND OF THE INVENTION

1. Field of the Invention

The present invention relates to a fastener cap strip that is useable with pneumatic type fastener drivers. In particular, the invention is directed towards a fastener cap strip that can be coiled without using a central core such as a cardboard tube.

2. Description of the Prior Art

Fastener caps are disks that have many times the surface area of the head of a fastener such as a roofing nail or staple. The fastener cap's extra surface area greatly increases the holding ability of fasteners that are used to fasten sheet material to a substrate. Each fastener cap has a top surface with a fastener head engaging section and a bottom surface for engaging and holding a sheet material to a substrate.

Fastener caps can be used manually during roof felt installation. In a manual procedure, the bottom surface of a fastener cap is placed against a roofing felt section just prior to a roofer driving a roofing nail into the fastener cap, roofing felt and substrate. The roofer holds the fastener cap in place with the point of the nail as he swings a carpenter's hammer to drive the nail into the fastener cap, roofing felt and substrate. Blow after blow of the hammer is delivered to the nail head until the nail's shank is driven substantially into the substrate and the nail's head engages the fastener cap's top surface. Nails and staples with pre-attached fastener caps have been developed for use with this type of manual installation.

While this manual procedure is effective, it is very inefficient. As a result, modern roofers use pneumatic nail guns to drive nails and staples. Whenever roofing felt is fastened to a roof, a fastener cap feeder assembly and a fastener cap magazine are attached to the pneumatic nail gun.

Typically, the fastener caps are plastic disks arranged into a strip. Adjacent disks are linked together by one or more thin breakable plastic members. However, fastener caps and breakable members making up a fastener cap strip are also made from thin sheet metal such as tin. The breakable members are flexible enough to allow the fastener caps to be coiled around a central core such as a hollow cardboard tube. The coil of fastener caps must be secured with rubber bands or adhesive tape to prevent uncoiling prior to use.

In operation, the adhesive tape or rubber band is removed from the coil and the coil of fastener caps is loaded into the pneumatic driver's magazine by placing the core over the magazine's central hub. When the pneumatic nail gun is triggered, a fastener cap disk is fed underneath the path of the nail being driven by the nail gun. Once the head of the nail engages the top surface of the disk, the pneumatic nail gun is moved to the next roof felt nail location. The movement of the nail gun from one location to another breaks the breakable member between the nailed fastener cap and the next fastener cap to be nailed.

Modern fastener cap strips are manufactured with a central core. A fastener cap strip is wound on the central core during the manufacturing process. The central core is a relatively costly item when compared to the cost of the fastener cap strip itself. The coils must be secured after winding with a rubber band or adhesive strip. Both the core and the means of securing the coil add expense to the coil strip. Therefore, a need exists for a fastener cap strip that does not need to be manufactured with a central core and without the need for an external means of securing the coil.

### SUMMARY OF THE INVENTION

The present invention addresses this need by providing a fastener cap structure along with a method of coiling the fastener cap strip that eliminates both the need for a central core and the need for external factors for securing the coil. In particular, the present invention provides a coiling method that results in an inner loop of fastener caps that substitutes for the central core, and a structure of the fastener caps that allows them to be secured without external mechanisms.

In general, the present invention is a strip of fastener caps made up of a plurality of disks including an inner coil disk and an end disk. Moreover, the preferred disks are circular with a given diameter that is at least twice as large as an engaging fastener head. Each disk has a circumferential edge with a breakable yet flexible member that is integral with each adjacent disk edge. A common centerline passes edgewise through each of the disks. The location of a first and second predetermined number of the breakable members alternates from one side of the common centerline to the other.

The inner coil disk includes a notch within its edge for engaging at least one breakable member connecting other disks within the strip of fasteners. The notch is located on the side of the inner coil disk opposite the location of the breakable member that attaches the inner coil disk to its adjacent disk. The notch in the inner coil disk allows for starting the coil without the need for a separate core piece. It also helps keep the coil intact by maintaining tension on the coiled strip. In addition, the notch is kept in place during the coiling operation due to the pressure of the coil itself.

The alternating pattern of breakable members is important because it allows for overlapping the caps at the end of the coil containing a fixed and known number of caps. If the number of caps in a coil change, the alternating cap strip pattern may be changed to accommodate the new total of caps in the coil. The preferred cap strip pattern has three breakable members on one side of the edgewise centerline and two on the other side. This structure accommodates cap coils of 160 and 200 disks (i.e., caps).

Tension throughout the coil is maintained by interlacing breakable members and disks of an outer coil loop with a predetermined number of breakable members and disks of an underlying coil loop. In a preferred embodiment the predetermined number of interlaced disks is three. This interlacing holds the cap coil together without the use of another external means such as tape, rubber bands or adhesive. The elimination of the core and external means of containment reduces the coil cost and makes totally automated cap coiling feasible.

The method of the present invention includes a step of coiling the plurality of disks into an inner loop such that the inner coil disk's notch engages a breakable member between other disks wherein the inner coil disk is immobile relative to the disks making up the inner disk loop. The inner coil loop is sized to fit snugly around a fastener cap magazine hub of a given diameter. The inner coil loop can consist of as few as three fastener caps, and thus be in the shape of a triangle. The size of the inner coil loop, however, is typically based upon customer requirements as to whether there is a magazine hub on the customer's particular application and, if so, the size of the magazine hub.

Another step coils loops of remaining disks around the inner loop of disks such that a predetermined number of breakable members from an outer loop of disks interlace with the breakable members of an underlying loop, thereby placing a predetermined number of outer loop disks inside an underlying disk loop. This step locks the coil of caps such that the coil is maintained during shipping, unpacking and loading into a cap strip magazine of a fastener gun.

In operation, the coil of fastener caps is loaded into the pneumatic driver's magazine by placing the inner loop of caps over the magazine's central hub. When the pneumatic nail gun is triggered, a fastener cap disk is fed underneath the path of the nail being driven by the nail gun. Once the head of the nail engages the top surface of the disk, the pneumatic nail gun is moved to the next roof felt nail location. The movement of the nail gun from one location to another breaks the breakable member or breakable members between the nailed fastener cap and the next fastener cap to be nailed.

### BRIEF DESCRIPTION OF THE DRAWINGS

FIG. 1 is a perspective view of a fastener cap strip according to the present invention.

FIG. 2 is a perspective view of a coreless inner loop formed from a fastener cap strip of the present invention.

FIG. 3 is a top view of another embodiment of the fastener cap strip according to the present invention.

FIG. 4 is a side view of the embodiment of FIG. 3.

### DETAILED DESCRIPTION OF THE PRESENT INVENTION

In the following description, terms such as horizontal, upright, vertical, above, below, beneath and the like are solely used for the purpose of clarity in illustrating the invention, and should not be taken as words of limitation. Also, like reference numerals represent like parts throughout the drawings. In addition, the drawings are for the purpose of illustrating the invention and are not intended to be to scale.

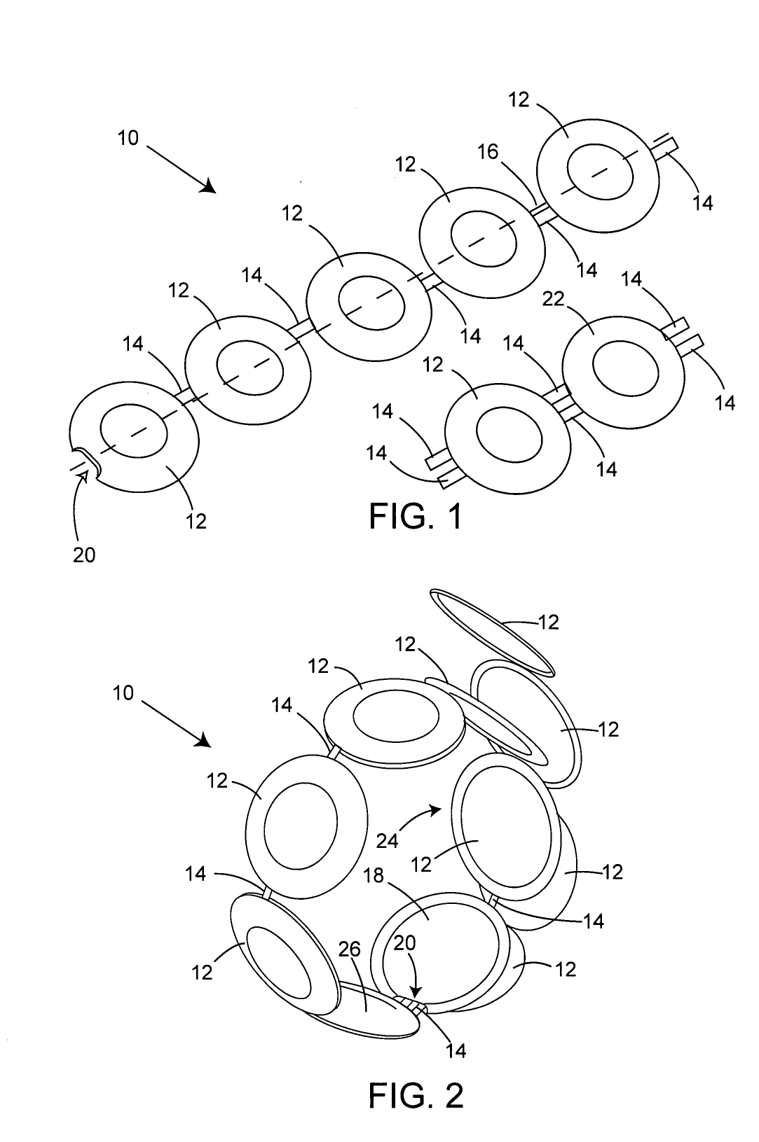

As shown in FIG. 1, a fastener cap strip, generally 10, is made up of a plurality of substantially circular disks 12. Breakable members 14 alternate in position from one side of an edgewise centerline 16 to the other. The breakable member alternation follows a patterned sequence. For example, as shown in FIG. 1, a first predetermined number of breakable members 14 is two and a second predetermined number of breakable members 14 is three. Two of breakable members 14 are positioned on one side of centerline 16 and three of breakable members 14 are positioned on the other side of centerline 16. The pattern can stop after one sequence or alternately the pattern can continue. However, after a given number of alternating sequences such as two or three sequences, it is preferred that breakable members 14 be positioned on both sides of centerline 16 for the purpose of strengthening cap strip 10. An inner coil disk 18 includes a notch 20 for engaging a breakable member that attaches a pair of disks that are adjacent to each other. An end disk 22 is usable to initially load a feeder attached to a pneumatic nail gun (not shown).

FIG. 2 shows the results of coiling a portion of strip 10 into an inner loop 24 such that notch 20 of inner coil disk 18 engages a breakable member 14 between other disks 12 wherein inner coil disk 18 is immobile relative to disks 12 making up inner disk loop 24. As strip 10 is nearly completely coiled, the alternating pattern of breakable members are interlaced with the breakable members of the last inner loop such that a predetermined number of disks at the end of the coil overlap, thereby maintaining tension on the coiled cap strip.

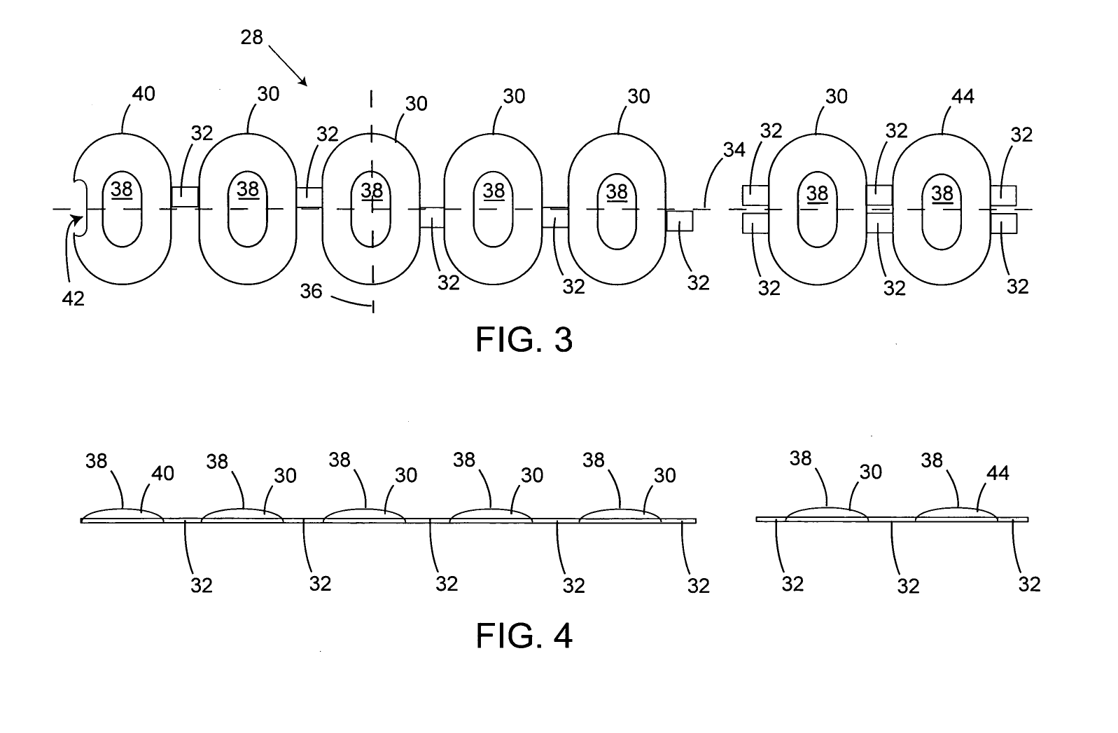

As shown in FIG. 3, a fastener cap strip 28 is made up of a plurality of substantially oval disks 30. Breakable members 32 alternate in position from one side of an edgewise centerline 34 to the other. In this embodiment, disks 30 also have a longitudinal axis 36 that is perpendicular to centerline 34. Moreover, each disk further includes a center section with an indentation 38 for centering a nail and/or engaging a fastener head. An inner coil disk 40 includes a notch 42 for engaging a breakable member that attaches a pair of disks that are adjacent to each other. An end disk 44 is usable to initially load a feeder attached to a pneumatic nail gun (not shown). FIG. 4 shows the fastener cap strip of FIG. 3 from a side or edgewise direction. The fastener cap strip of FIGS. 3 and 4 are coilable in the same fashion as the cap strip of FIGS. 1 and 2.

Certain modifications and improvements will occur to those skilled in the art upon a reading of the foregoing description. Such modifications and improvements have been deleted herein for the sake of conciseness and readability but are properly within the scope of the following claims.

What is claimed is:

1. A strip of fastener caps for use with a staple/nail cap fastener comprising a plurality of disks including an inner coil disk and an end disk, wherein each of the plurality of disks has a common centerline passing through the center of each adjacent disk, wherein each of said plurality of disks has a circumferential edge with a breakable member integral with said circumferential edges of adjacent disks and wherein said breakable member is flexible, wherein the location of a first and second predetermined number of said breakable members alternates from a first side of said common center line to a second side of said common center line.

2. The strip of fastener caps of claim 1, wherein said inner coil disk includes a notch within its circumferential edge along said centerline and opposite said breakable member connecting to and adjacent disk, said notch of sufficient width to engage at least one breakable member connecting other disks within said strip of fasteners.

3. The strip of fastener caps of claim 1, wherein said disks are circular.

4. The strip of fastener caps of claim 1, wherein said disks are oval with a longitudinal axis.

5. The strip of fastener caps of claim 4, wherein each oval disk longitudinal axis is perpendicular to said common centerline.

6. The strip of fastener caps of claim 4, wherein each of said oval disks include an indentation for engaging a fastener head.

7. The strip of fastener caps of claim 1, wherein said disks are made of plastic.

8. The strip of fastener caps of claim 1, wherein said integral breakable members are made of plastic.

9. The strip of fastener caps of claim 1, wherein said disks are made of tin.

10. The strip of fastener caps of claim 1, wherein said integral breakable members are made of tin.

11. A method of coiling a strip of fastener caps without using a central core, said method comprising:
providing a strip of fastener caps for use with a staple/nail cap fastener comprising a plurality of disks including an inner core disk and an end disk, wherein each of the plurality of disks has a common centerline passing through the center of each adjacent disk, wherein each of said plurality of disks has a circumferential edge with breakable member integral with said circumferential edges of adjacent disks and wherein said breakable member is flexible, wherein the location of a first and second predetermined number of said breakable members alternates from a first side of said common center line to a second side of side common center line;
providing a notch within the edge of the inner coil disk for engaging at least one breakable member connecting other disks within said strip of fasteners;
coiling the plurality of disks into an inner loop such that the inner coil disk's notch engages a breakable member between other disks wherein the inner coil disk is immobile relative to the disks making up said inner disk loop;
coiling loops of remaining disks around said inner loop of disks such that a predetermined number of breakable members from an outer loop of disks interlace with the breakable members of a underlying loop, thereby placing a predetermined number of outer loop disks inside the underlying disk loop.

13. The method of claim 11, wherein said disks and breakable members are made of plastic.

14. The method of claim 11, wherein said disks and breakable members are made of tin.

15. The method of claim 11, wherein said first predetermined number of breakable members is two.

16. The method of claim 11, wherein said second predetermined number of breakable members is three.

17. The method of claim 11, wherein said disks are circular with a given diameter that is at least twice as large as an engaging fastener head.

18. The method of claim 11, wherein said disks include an indentation for engaging a fastener head.

19. A method of coiling a strip of fastener caps without using a central core, said method comprising:
providing a strip of fastener caps for use with a staple/nail cap fastener comprising a plurality of disks including an inner core disk and an end disk, wherein each of the plurality of disks has a common centerline passing through the center of each adjacent disk, wherein each of said plurality of disks has a circumferential edge with breakable member integral with said circumferential edges of adjacent disks and wherein said breakable member is flexible, wherein the location of a first and second predetermined number of said breakable members alternates from a first side of said common center line to a second side of side common center line;
forming an inner loop sized to fit snugly around a fastener cap magazine hub of a given diameter;
coiling loops of remaining disks around said inner loop of disks such that a predetermined number of breakable members from an outer loop of disks interlace with the breakable members of a underlying loop, thereby placing a predetermined number of outer loop disks inside the underlying disk loop.

20. The method of claim 19, wherein further steps include:
providing a notch within the edge of the inner coil disk for engaging at least one breakable member connecting other disks within said strip of fasteners;
coiling the plurality of disks into an inner loop such that the inner coil disk's notch engages a breakable member between other disks wherein the inner coil disk is immobile relative to the disks making up said inner disk loop.
